(19) United States
(12) Patent Application Publication
(10) Pub. No.: US 2011/0171600 A1
(43) Pub. Date: Jul. 14, 2011

(54) Bio-Implant Having a Screw Body with Nanoporous Spiral Groove and the Method of Making the Same

(75) Inventors: Chung-Kuang Yang, Taipei (TW); Sea-Fue Wang, Taipei (TW); Sheng-Yang Lee, Taipei (TW); Jen-Chang Yang, Taipei (TW); I-lin Ho, Taipei (TW)

(73) Assignee: NATIONAL TAIPEI UNIVERSITY OF TECHNOLOGY, Taipei (TW)

(21) Appl. No.: 12/777,504

(22) Filed: May 11, 2010

(30) Foreign Application Priority Data
Jan. 14, 2010 (TW) 99100977

(51) Int. Cl. A61C 8/00; C25D 5/00; C23C 14/00

(52) U.S. Cl. 433/174; 205/91; 204/192.11

(57) ABSTRACT

A bio-implant having a screw body selectively formed with nanoporous channels structure in a spiral groove and the method of making the same are disclosed. Nanoporous channels structure formed into the spiral groove of the bio-implant is carried out by the heat treatment in vacuum firstly and anodic treatment secondly. Thereafter, bioactive material is filled into the nanoporous and deposited on the implant surface by an electro-deposition process so as to increase the bioactivity and biocompatibility of the bio-implant.

### FIELD OF THE INVENTION

The present invention relates to a bio-implant, particularly, to the bio-implant with a bioactive material and a nanoporous channels structure surface and fabricating method thereof.

### BACKGROUND OF THE INVENTION

Generally speaking, the bio-implant should not cause blood coagulation and hemolysis reaction, or release any toxicant. When choosing an implant, the biocompatibility is firstly considered.

Stainless steel, titanium alloy, and cobalt-chromium alloy are the widely-used metallic biological materials, and the titanium is the most widely-used metal. In the environment with air, water or physiological, the titanium spontaneously forms a stable titanium oxide film with good biocompatibility on the surface. As the report, the titanium oxide with an anatase structure improves the absorption of the protein and decreases the fiber tissues. However, the titanium oxide is an inertia material. Filling titanium oxide into the unhealthy bone physiological environment does not have a good healing effect, as expected.

For example, a dental implant with a smooth and stable surface releases fewer toxicants and irritants, but hardly binds the surrounding tissues. Thus, a fibrous capsule of 0.1˜10 μm is formed around the dental implant with a smooth and stable surface by the surrounding tissues.

The fibrous capsule does not bind the dental implant. Fibrous capsule continues to thicken and blocks blood supply, so waste accumulates around the dental implant and inflammatory tissues are formed. Fibrous capsule calcification and sclerosis occur and causes local pain; moreover, the dental implant and the nearby tissues are damaged or hurt, or the dental implant loosens because of the unbalanced stress.

In order to prevent the problems mentioned above, the surface modification such as etching, surface coating method, sintering method, etc, are applied to the dental implant.

After traditional sandblasting treatment, the pores with different pore sizes are formed on the surface of a dental implant. The dental implant has a lower mechanical strength. The average depth of the pores is in the micrometer range, so it is hard to be bounded by new cells. If the surface is not cleaned carefully after the traditional sandblasting treatment, it would cause irritation. The sandblasting treatment can not select the sandblasting position. When the pressure on the dental implant is larger than the Young's modulus, the dental implant can be broken or deformed easily.

When using the coating method as the surface modification method, the coating material does not bind the surface of the dental implant by chemical bonds. After a long time, the coating material loosens easily.

When using the sintering method as the surface modification method, the sintering method will change the crystal structure, chemical properties and physical properties of the dental implant.

In order to help the bone cell growth, sometime people will add some active materials on the dental implant. The most widely used method is plasma technologies. The temperature of the plasma technologies is about 1000° C., and active materials will be deposited on a substrate. The plasma technologies have some problems. At a high temperature, some active materials transform into an amorphous phase. The amorphous active materials influence the dental implant to bind the active materials and the surrounding tissue.

A patent (TW 0933117549) discloses a nanoporous bio-implant with suckers and the method fabrication thereof by electrochemistry method. The pore wall does not connect to each other, so the pore wall is too thin. Thus, the bio-implant has lower mechanical strength and the dental implant can be broken or deformed easily.

Therefore, how to fabricate a dental implant with high mechanical strength and biocompatibility, and without the problems mentioned above is important.

### SUMMARY OF THE INVENTION

The present invention discloses a bio-implant having a screw body and a nanoporous channels structure surface. The nanoporous channels structure surface is only formed into the spiral groove of the screw body. Thereafter, bioactive material can be filled into the nanoporous channels structure and deposited on the implant surface by an electro-deposition process so as to increase the bioactivity and biocompatibility of the bio-implant.

The present invention discloses a method for the selective surface modification on the bio-implant having a screw body. The method comprises providing a bio-implant having a screw body; cleaning the surface of the bio-implant; performing a heat treatment carried out in vacuum, an inert gas, or blunt gas; performing an anodic treatment to the bio-implant. The anodic treatment forms a metal oxide thin film on the surface of the bio-implant and a nanoporous channels structure on the surface of said bio-implant. The nanoporous channels structure is only formed into spiral groove of the spiral groove and the electrolyte solution of the anodic treatment comprises fluoride ion.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A shows a schematically diagram of the dental implant in a human body of the present invention;

FIG. 1B shows the dental implant of the present invention;

FIG. 1C shows an enlarged view of the dental implant of the present invention;

FIG. 1D is a cross-sectional view of the dental implant along the AA line in FIG. 1C;

FIG. 2 shows a schematically diagram of the method for the selective surface modification; and

FIG. 3A-3D show a schematically diagram of the anodic treatment and the nanoporous channels structure is formed on the surface of the bio-implant.

### DETAILED DESCRIPTION OF THE PREFERRED EMBODIMENT

The present invention provides a bio-implant having a screw body. The bio-implant can be used as a dental implant, bone plates and screws. The present invention provides a dental implant and figures with detail description as an example.

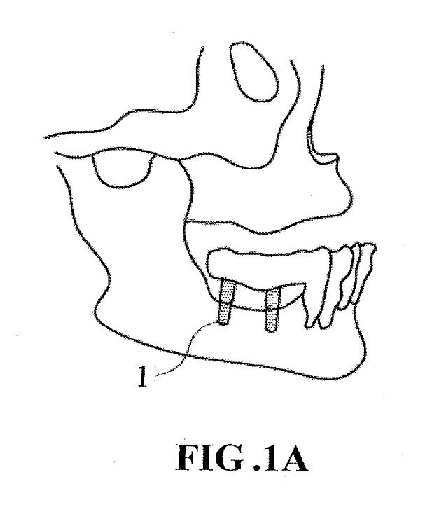

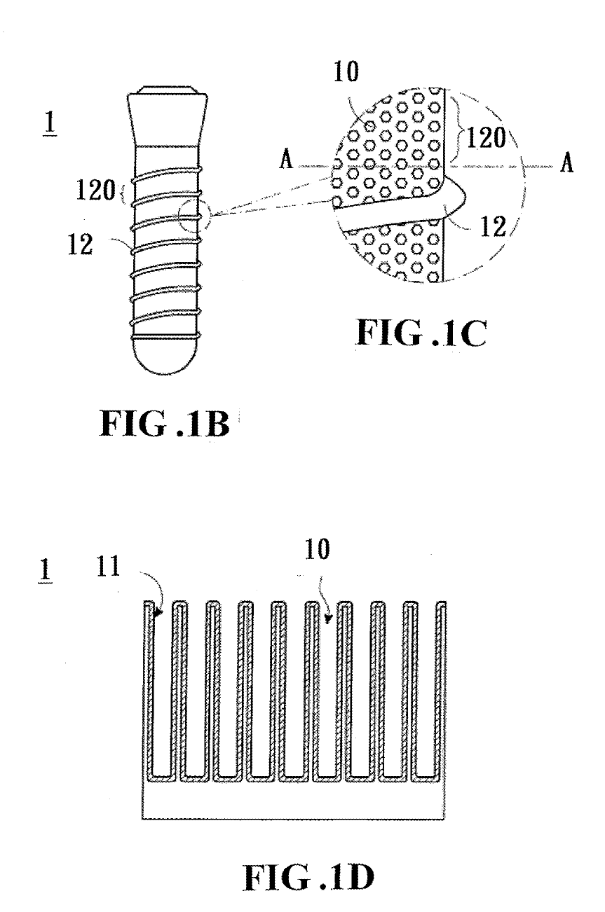

As shown in FIG. 1A to 1D, FIG. 1A is a schematically diagram of the dental implant in a human body and FIG. 1B shows the dental implant of the present invention.

The bio-implant should not cause pathological changes, so the material must have biocompatibility. The biocompatibility metal or alloy can be choosing as the bio-implant material. The present invention chooses titanium as the bio-implant material 1.

Titanium will form titanium oxide on the surface. Titanium oxide is a stable ceramic material, is hard to react with other material. The biocompatibility of titanium is better than the biocompatibility of aluminum oxide and zirconia oxide. The titanium oxide with rutile structure can have the biocompatibility and prevent the titanium ion releasing.

FIG. 1C shows an enlarged view of the dental implant. FIG. 1D is a cross-sectional view of the dental implant along the AA line in the FIG. 1C. The dental implant has several nanopores 10 and at least one bio-active material 11.

In order to grow bone cells in the dental implant, the surface of the dental implant has several nanopores and the average diameter of the pores ranges from 10 to 500 nm. Because average diameter of the pores influences the mechanical strength of the dental implant, the preferred average diameter of the pores ranges from 10 to 80 nm. The preferred distance between two nearby pores is more than 5 nm. The distance between two nearby pores can be controlled as the situation.

As shown in FIG. 1D, the bioactive material 11 can be filled into the nanoporous channels structure 10 and deposited on the surface of said bio-implant 1 for increasing the bioactivity and biocompatibility of the bio-implant. The bioactive material 11 with osteoconductive property and osteoinductive property helps the bone growth and reduces osseointegration time. The bioactive material 11 comprises calcium, phosphorous, and hydroxyl group. In a preferred embodiment, the bioactive material is calcium phosphate (Hydroxylapatite). The hydroxyapatite with good biocompatibility and Ca/P mole ratio of 1.67 is similar to the bone with Ca/P mole ratio of 1.6. The hydroxyapatite is used as a substrate for new bone cell to grow on it by chemical bond.

In a preferred embodiment, the bio-implant 1 having a thread 12 for fixing the bio-implant in the gum. The thread 12 has less mechanical strength than the spiral groove 120, so the nanoporous channels structure (nanopores 10) is only formed into the spiral groove 120.

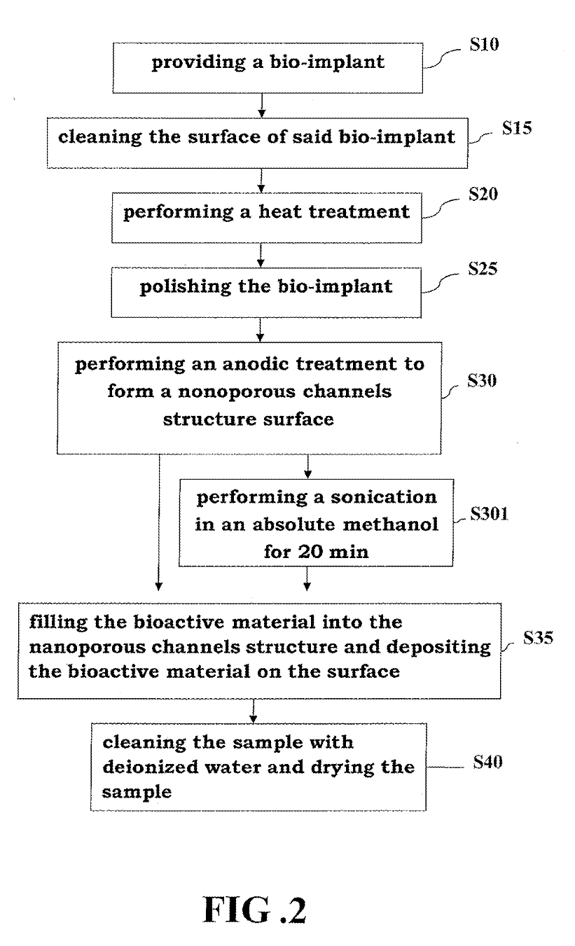

The present invention provides a method for the selective surface modification on the bio-implant having a screw body. FIG. 2 is a schematically diagram of the method. The purpose of the selective surface modification is to form several nanopores on the surface of the bio-implant. The present invention is not limited in the preferred embodiment. The knee implant, orthopedic implant and etc can be formed with nanopores structure by the method of present invention. The present invention discloses the method for the selective surface modification on the bio-implant having a screw body, comprising:

S10: Provide a bio-implant having a screw body. The bio-implant is a biocompatibility metallic implant or a biocompatibility alloy implant. The preferred bio-implant is a titanium or titanium alloy dental implant.

S15: Clean the surface of the bio-implant. The defect and impurities on the surface influence the nanoporous channels structure. In a preferred embodiment, the bio-implant can be cleaned by sonication to remove the impurities. The solvent of the sonication is acetone, ethanol, and deionized water individually.

S20: Perform a heat treatment to the bio-implant. The stress effect would vanish and the density of the oxide layer increases. The heat treatment can be carried out in vacuum, an inert gas, or blunt gas. The purpose of the heat treatment is to let the pores be formed into the spiral groove 120 which is between two threads 12, and reduces the pores be formed into the thread 12. Because the pressure at the thread is larger than the pressure at the spiral groove, the thread with nanoporous channels structure can be broken easily.

The top of the metal becomes metal oxide easily. Under the heat treatment, the top of the metal oxide gets lots of heat. The oxide layer 13 becomes denser and becomes a protective layer. When performing an anodic treatment, the protective layer prevents the nanoporous channels structure formed into the thread 12. If the heat treatment is carried out in the air, the oxide layer 13 on the surface becomes too thick to form the nanoporous channels structure. The preferred heat treatment carried out in vacuum, an inert gas, or blunt gas. In a preferred embodiment, the heat treatment is carried out in vacuum (10⁻¹ to 10⁻⁸ torr), and the temperature of said bio-implant in said heat treatment is between 200° C. and 900° C. In another preferred embodiment, the heat treatment is carried out in vacuum (10⁻² to 10⁻⁴ torr), and the temperature of said bio-implant in said heat treatment is between 600° C. and 700° C.

S13: Polish the bio-implant in a polishing slurry by electrochemistry method. The polishing slurry is a mixture of ethylene glycol Butyl ether (EG), methanol, and perchloric acid. An anode is the bio-implant and a cathode is the platinum (Pt, 999.9%). Then, soak the bio-implant in an absolute methanol and perform a sonication to remove the outcome of the polishing process.

S30: Perform an anodic treatment to the bio-implant. The anodic treatment forms a metal oxide thin film 13 on the surface of the bio-implant, and then a nanoporous channels structure 10 is formed on the surface of the bio-implant 1. The nanoporous channels structure is only formed into spiral groove of the spiral groove. The nanoporous channels structure can improve the contact area of the bio-implant and the bone tissues, and the effects of mechanical interlocking.

The electrolyte solution of the anodic treatment comprises fluoride ion. In a preferred embodiment, the electrolyte solution comprises NH₄F, ethylene glycol, and deionized water. An anode is the bio-implant and a cathode is the platinum (Pt, 999.9%). The anodic treatment is carried out in the electrolyte solution. Changing the voltage, electric current, reaction time, reaction temperature, and the concentration of the fluoride ion can control the average diameter of the pore size. For example, the average pore diameter of the nanoporous channels structure ranges from 10 to 500 nm. The preferred average pore diameter of the nanoporous channels structure ranges from 10 to 80 nm and the distance between two nearby pore is more than 5 nm to keep the bio-implant 1 with enough mechanical strength. The concentration of NH₄F ranges from 0.1 to 20 wt %. In a preferred Embodiment, the NH₄F ranges from 0.1 to 0.4 wt %. The voltage of the anodic treatment is between 10 and 90 volts, and the preferred voltage is 40 volts. The reaction time of the anodic treatment ranges from 5 to 1200 minutes.

After performing the anodic treatment, soak said bio-implant in an absolute methanol and perform a sonication 5301 for 20 minutes to remove the electrolyte solution.

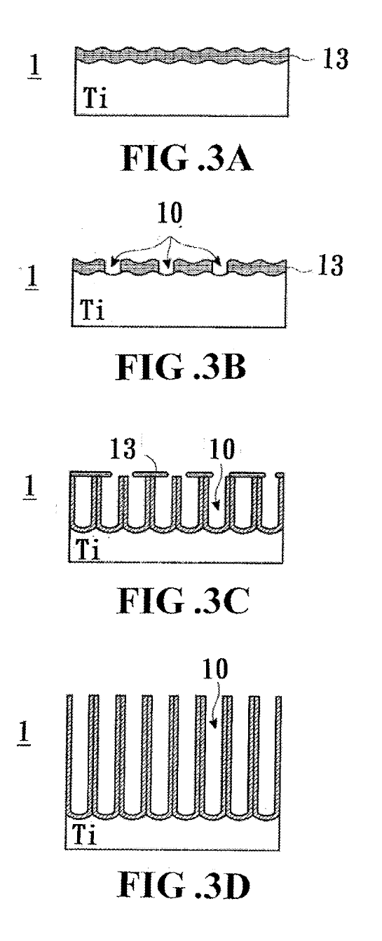

As shown in FIG. 3, the anodic treatment forms the vertical nanoporous channels array on the surface of the bio-implant. In a preferred embodiment, the oxidative reaction at titanium (Ti) provides titanium ion (Ti⁴⁺). While the partial of anode dissolves (the chemical reaction 1), the electrolysis of water is happened. Water (H2O) is decomposited into oxygen ion (O²⁻) and hydrogen ion (H+) (the chemical reaction 2). Then, titanium ion (Ti⁴⁺) combines with oxygen ion (O²⁻) forming a titanium oxide thin film 13 called barrier layer (the chemical reaction 3; FIG. 3A).

Ti+4e⁻→Ti⁴⁺ (1)

H₂O→2H⁺+O²⁻ (2)

Ti⁴⁺+20²⁻→TiO₂ (3)

As shown in FIG. 3B, fluoride ion makes the titanium oxide thin film has partial chemical dissolution and forms the porous layer (the chemical reaction 4).

TiO₂+6F⁻+4H⁺→[TiF₆]²⁻+2H₂O (4)

As the reaction time increases, the depth and the average pore diameter increase. The pore structure turns into a tube structure. The more reaction time it has and the more depth, average pore diameter it has. The pore wall becomes thinner (FIG. 3C and FIG. 3D).

The pore structure is vertical nanoporous channels. The pores channels do not connect to each other, so the bio-implant having good mechanical strength can not be broken easily.

Why does the bio-implant have channel pore structure? The reasons are as follows. Defect with lower free energy comprises dislocation, pore, grain boundary, precipitates, and etc. When the electric current is pass through the bio-implant, the current aggregates at the defect area. The chemical dissolution occurs at the defect area. The electrolyte solution comprises fluoride ion (F⁻), so [TiF₆]²⁺ is formed at the defect area. The concentration of [TiF₆]²⁺ at the defect area is more than the other area, so the concentration diffusion occurs.

Perform heat treatment to the bio-implant having a screw body. The oxide layer on the surface of the thread becomes dense, so the nanoporeous channels structure is selectively formed into the spiral groove.

S35: Fill the bioactive material into the nanoporous channels structure and deposits the bioactive material on the surface of the bio-implant. The bioactive material comprises calcium, phosphorous, and hydroxyl group. In a preferred embodiment, the bioactive material deposits on the surface of the bio-implant by electric deposition. Actually, the deposition method is not limited at the electric deposition. The deposition method comprises plasma method, immersion method, sol-gel method, and ion beam sputtering deposition.

The electrolyte solution of the electric deposition comprises phosphorous ion and calcium ion. Dissolve calcium precursor and phosphorous precursor, such as CaCl₂ and NH₄H₂PO₄, into deionized water. The bio-implant is seated at the cathode and the platinum is seated at the anode. Put the cathode and the anode into the electrolyte solution. Control the reaction factors and perform the electric deposition to fill or coat the bio-active material. The reaction factors comprise voltage, reaction time, reaction temperature, the composition of the electrolyte solution, pH, and etc.

S40: Clean the sample with deionized water and then dry the sample in an oven.

The present invention discloses a method for the selective surface modification on the bio-implant having a screw body. The bio-implant after surface modification has the advantages of the following:

1. The nanoporous channels structure is only formed into the spiral groove of said screw body. While the bio-implant is under the pressure, the pressure on the spiral groove is less than the pressure on the thread. The spiral groove with the nanoporous channels structure can not be broken easily.

2. The vertical nanoporous channels do not connect to each other, so the bio-implant has good mechanical strength.

3. By increasing the osteoconductive effect and the contact surface between the bone tissue and the surrounding tissue, it is easy for the bone to grow into the bio-implant.

4. By filling the bioactive material into the nanoporous channels structure and the surface of said bio-implant via the electrochemistry method, the bio-implant has the osteoinductive effect and less osseointegration time.

The method for the selective surface modification on the bio-implant having a screw body can increase the contact surface, have the osteoconductive and osteoinductive effect, and reduce the osseointegration time.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

What is claimed is:

1. A bio-implant having a screw body, the surface of said bio-implant comprising:
a nanoporous channels structure, wherein said nanoporous channels structure is only formed into the spiral groove of said screw body.

2. The bio-implant according to claim 1, wherein said bio-implant is a metallic implant or an alloy dental implant.

3. The bio-implant according to claim 2, wherein the material of said dental implant is titanium.

4. The bio-implant according to claim 1 further comprising a bioactive material filled into the nanoporous channels structure and deposited on the surface of said bio-implant for increasing the bioactivity and biocompatibility of said bio-implant.

5. The bio-implant according to claim 4, wherein said bioactive material comprises calcium, phosphorous, and hydroxyl group.

6. The bio-implant according to claim 1, wherein said nanoporous channels structure is a vertical nanoporous channels structure, wherein the distance between two nearby nanoporous channels is more than 5 nm and the average diameter of the nanoporous channels ranges from 10 to 500 nm.

7. A method for the selective surface modification on the bio-implant having a screw body, said method comprising:
providing a bio-implant, said bio-implant having a screw body, and said bio-implant is a metallic implant or an alloy implant;
cleaning the surface of said bio-implant;
performing a heat treatment to said bio-implant; and
performing an anodic treatment to said bio-implant, wherein said anodic treatment forms a metal oxide thin film on the surface of said bio-implant and a nanoporous channels structure on the surface of said bio-implant, wherein said nanoporous channels structure is only formed into spiral groove of the spiral groove and the electrolyte solution of said anodic treatment comprises fluoride ion.

8. The method according to claim 7, wherein said heat treatment is carried out in vacuum, an inert gas, or blunt gas.

9. The method according to claim 7, wherein said heat treatment is carried out in vacuum (10⁻¹ to 10⁻⁸ torr), and the temperature of said bio-implant in said heat treatment is between 200° C. and 900° C.

10. The method according to claim 7, wherein said bio-implant is a titanium (Ti) or titanium alloy material.

11. The method according to claim 7 further comprising a process between performing said heat treatment and performing said anodic treatment, wherein said process comprises:
polishing said bio-implant in a polishing slurry by an electrochemistry method, wherein said polishing slurry is a mixture of ethylene glycol Butyl ether (EG), methanol, and perchloric acid; and
performing a sonication on said bio-implant in an absolute methanol to remove the outcome of polishing said bio-implant.

12. The method according to claim 7, wherein said electrolyte solution of said anodic treatment further comprises NH₄F, ethylene glycol, and deionized water, wherein the concentration of the NH₄F ranges from 0.1 to 20 wt %.

13. The method according to claim 12, wherein said concentration of the NH₄F ranges from 0.1 to 0.4 wt %.

14. The method according to claim 7, after performing an anodic treatment to said bio-implant, the method further comprising: filling a bioactive material into the nanoporous channels structure and depositing the bioactive material on the surface of said bio-implant for increasing the bioactivity and biocompatibility of said bio-implant.

15. The method according to claim 14, wherein said filling the bioactive material into the nanoporous channels structure and depositing the bioactive material on the surface of said bio-implant are made via electro deposition, plasma method, immersion method, sol-gel method, or ion beam sputtering deposition

16. The method according to claim 14, wherein said bioactive material comprises calcium, phosphorous, and hydroxyl group.

17. The method according to claim 14, wherein said filling said bioactive material into the nanoporous channels structure and depositing said bioactive material on the surface of said bio-implant are made via electric deposition, wherein the electrolyte solution of said electric deposition comprises phosphorous ion and calcium ion.

18. The method according to claim 7, wherein the voltage of said anodic treatment is between 10 and 90 volts, and the reaction time of said anodic treatment ranges from 5 to 1200 minutes.

19. The method according to claim 7, wherein the average pore diameter of the nanoporous channels structure ranges from 10 to 500 nm, and controlling the voltage, electric current, reaction time, reaction temperature, and the concentration of the fluoride ion yields said bio-implant with a vertical nanoporous channels structure.
